(19) United States
(12) Patent Application Publication
(10) Pub. No.: US 2002/0088933 A1
(43) Pub. Date: Jul. 11, 2002

(54) Device displacement measuring apparatus

(76) Inventors: Meng-Chi Yu, Taichung (TW); Su-Chen Liao, Taichung (TW)

Correspondence Address: BROWDY AND NEIMARK, P.L.L.C., 624 NINTH STREET, NW, SUITE 300, WASHINGTON, DC, 20001-5303, US

(21) Appl. No.: 09/757,670

(22) Filed: Jan. 11, 2001

(51) Int. Cl. G01D 5/34

(52) U.S. Cl. 250/231.13

(57) ABSTRACT

A device displacement measuring apparatus includes a housing fixedly fastened to the movable device to be measured which is to be reciprocated in a predetermined path, an optical grid, an input shaft adapted to rotate the optical grid upon movement of the movable object, a light emitter adapted to emit light through peripheral through holes of the optical grid, a light sensor adapted to receive light from the light emitter through the peripheral through holes of the optical grid and to convert light signal into electronic signal for output, a counting and display circuit adapted to convert signal from the light sensor into numerical data for display through a LCD.

### BACKGROUND OF THE INVENTION

The present invention relates to a measuring instrument adapted to measure the amount of movement of a movable device in a working machine.

For measuring the amount of displacement of a movable object in a machine, for example, for measuring the amount of displacement of the cutter holder of a cutting metal-working machine or bench saw, a rule is fixedly provided at one side of the path in which the cutter holder is reciprocated, and an index is marked on the cutter holder. By means of reading the reading at which the index is aimed, the amount of displacement of the cutter holder is judged. This visual measuring method is less accurate. There is known another method using a sophisticated optical measuring instrument to measure the amount of displacement of the cutter holder. This sophisticated optical measuring instrument is functional and achieves high precision. However, the manufacturing cost of this sophisticated optical measuring instrument is high because it uses a big amount of electronic and optical elements.

### SUMMARY OF THE INVENTION

The present invention has been accomplished under the circumstances in view. It is the main object of the present invention to provide a device displacement measuring apparatus, which achieves high precision, and effectively eliminates the possibility of a reading error. It is another object of the present invention to provide a device displacement measuring apparatus, which is inexpensive to manufacture. To achieve these and other objects of the present invention, a device displacement measuring apparatus is provided comprised of a housing fixedly fastened to the movable device to be measured which is to be reciprocated in a predetermined path, an optical grid pivoted to the inside of the housing, the optical grid comprising a series of peripheral through holes equiangularly spaced around the center thereof at an equal distance, a light emitter provided inside the housing at one side of the optical grid and adapted to emit light through the peripheral through holes of the optical grid, a light sensor provided inside the housing at one side of the optical grid opposite to the light emitter and adapted to receive light from the light emitting diode through the peripheral through holes of the optical grid and to convert the received light signal into a corresponding electronic signal for output, an input shaft pivoted to the housing at one side and connected to the center of the optical grid for synchronous rotation, an input gear fixedly mounted on one end of the input shaft remote from the optical grid, a counting and display circuit adapted to count the number of electronic signals received from the optical sensor and to convert the sum into a numerical data signal for display through a LCD, and a rack fixedly provided at one side of the path in which the object to be measured is reciprocated and meshed with the input gear, for enabling the input shaft to be rotated upon movement of the object to be measured.

### BRIEF DESCRIPTION OF THE DRAWINGS

FIG. 1 is perspective view, partially in section, of a device displacement measuring apparatus according to the present invention.

FIG. 2 is an applied view of the present invention, showing the device displacement measuring apparatus installed in a cutting metal-working machine.

FIG. 3 is a side view of the present invention, showing the device displacement measuring apparatus operated.

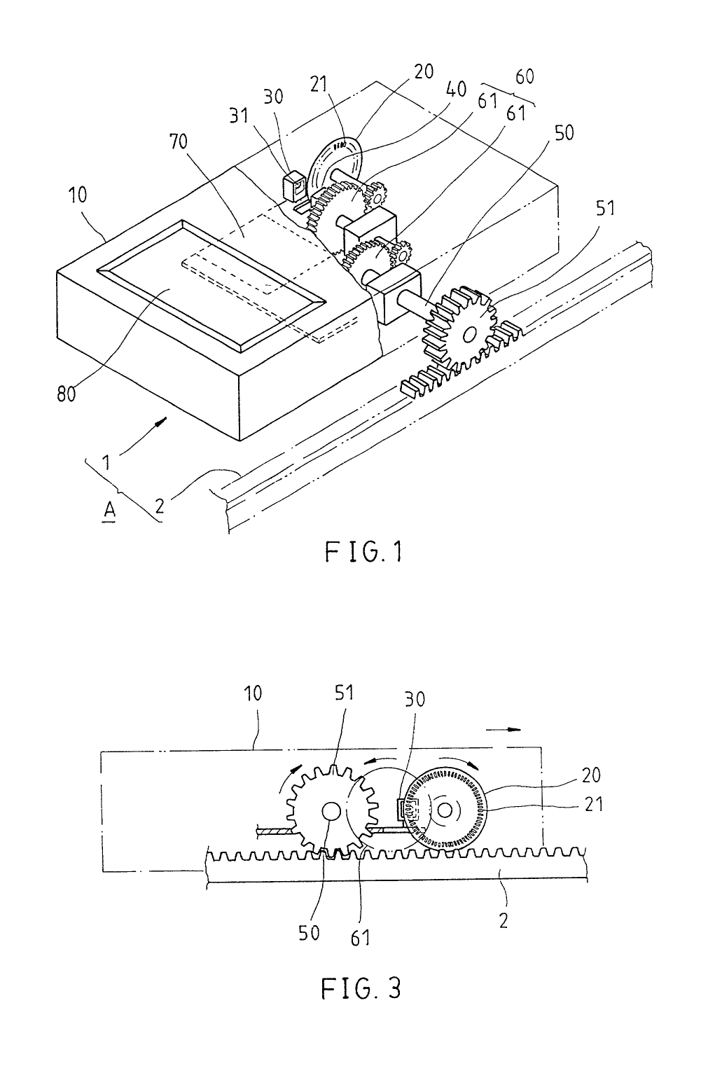

### DETAILED DESCRIPTION OF THE PREFERRED EMBODIMENT

Referring to FIGS. from 1 through 3, a device displacement measuring apparatus A is shown comprised of a counting device 1, and a rack 2. The counting device 1 comprises a housing 10, an optical grid 20, a light emitter 30, a light sensor 40, an input shaft 50, an amplification gear train 60, and a counting and display circuit 70.

The housing 10 is fastened to the movable device to be measured, for example, the cutter holder B of a cutting metal-working machine. The cutter holder B is reciprocated in a predetermined path in the cutting metal-working machine. The optical grid 20 is shaped like a disk pivoted to the inside of the housing 10, comprising a series of peripheral through holes 21 equiangularly spaced around the center thereof at an equal distance. The light emitter 30 is provided near one side of the optical grid 20, comprising a light emitting diode 31 controlled to emit light. The light sensor 40 comprises a photosensitive transistor (not shown) disposed near one side of the optical grid 20 opposite to the light emitter 30 and adapted to receive light from the light emitting diode 31 through the peripheral through holes 21 of the optical grid 20 and then to convert the received light signal into a corresponding electronic signal for output. When rotating the optical grid 20, the optical grid 20 intermittently stop the light of the light emitting diode 31 from passing to the light sensor 40, thereby causing the light sensor 40 to receive the light of the light emitting diode 31 intermittently, and then to convert the light signal into a corresponding electronic signal for output. The input shaft 50 is pivoted to the housing 10 at one side, having an input gear 51 at one end thereof. The amplification gear train 60 is comprised of a set of transmission gears 61 of different number of teeth respectively pivoted to the inside of the housing 10 and coupled between the input shaft 50 and the optical grid 20 for enabling the optical grid 20 to be rotated at a higher speed than the input shaft 50 upon rotary motion of the input shaft 50. The counting and display circuit 70 is adapted to count the number of electronic signals received from the optical sensor 40, and then to convert the sum into a numerical data signal for output through a liquid crystal display 80, which is mounted on the housing 10. The rack 2 is fixedly provided at one side of the path in which the cutter holder B is reciprocated, and meshed with the input gear 51 of the input shaft 50, for enabling the input shaft 50 to be rotated upon movement of the cutter holder B in the path.

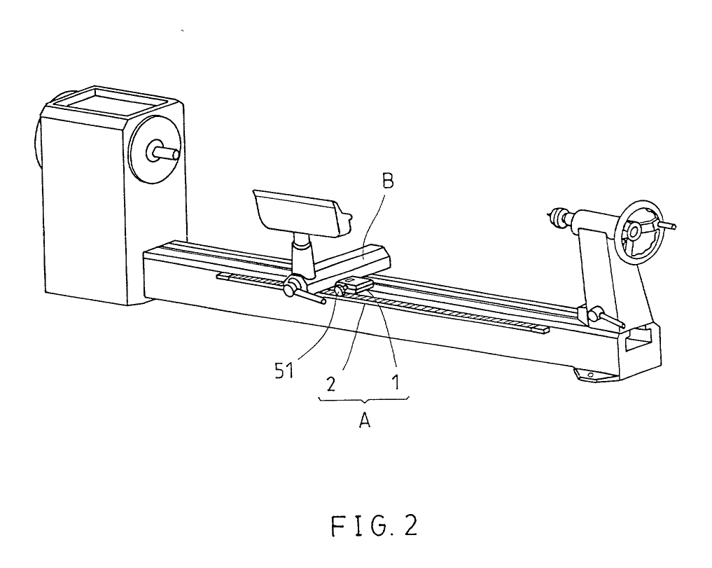

Referring to FIG. 2 again, the device displacement measuring apparatus A is fixedly fastened to the cutter holder B of the cutting metal-working machine, and adapted to measure the amount of displacement (feed) of the cutter holder B. The rack 2 is fixedly provided at the work table of the cutting metal-working machine at one side of the path in which the cutter holder B is moved. The input gear 51 is maintained meshed with the rack 2.

Referring to FIGS. from 1 through 3 again, during movement of the cutter holder B, the input gear 51 and the input shaft 50 are rotated on the rack 51, thereby causing the amplification gear train 60 to rotate the optical grid 20 at a speed higher than the input shaft 50. Upon rotary motion of the optical grid 20, the light sensor 40 receives the light of the light emitter 30 intermittently and outputs to the counting and display circuit 70 a number of electronic signals corresponding to the angle of rotation of the optical grid 20 which is indicative of the amount of movement of the cutter holder B, causing the counting and display circuit 70 to count the number of electronic signals and to convert the sum into a numerical data signal indicative of the amount of movement of the cutter holder B for display through the liquid crystal display 80.

As indicated above, the device displacement measuring apparatus A accurately measures the amount of displacement of an object, and shows the amount of displacement by a numerical data signal to prevent a reading error. Further, because the device displacement measuring apparatus A uses a limited number of inexpensive component parts, the manufacturing cost of the device displacement measuring apparatus A is low.

Further, the invention can be used in any of a variety of cutting metal-working as well as wood-working machines such as drilling machines, metal-planers, shaping machines, metal-milling machines, bench saws, and etc.

It is to be understood that the drawings are designed for purposes of illustration only, and are not intended for use as a definition of the limits and scope of the invention disclosed.

What the invention claimed is:

1. A device displacement measuring apparatus comprising:
a housing fixedly fastened to the movable device to be measured, which is to be reciprocated in a predetermined path;
an optical grid pivoted to the inside of said housing, said optical grid comprising a series of peripheral through holes equiangularly spaced around the center thereof at an equal distance;
a light emitter provided inside said housing at one side of said optical grid and adapted to emit light through the peripheral through holes of said optical grid;
a light sensor provided inside said housing at one side of said optical grid opposite to said light emitter and adapted to receive light from said light emitting diode through the peripheral through holes of said optical grid and to convert the received light signal into a corresponding electronic signal for output;
an input shaft pivoted to said housing at one side and connected to the center of said optical grid for synchronous rotation;
an input gear fixedly mounted on one end of said input shaft remote from said optical grid;
a counting and display circuit adapted to count the number of electronic signals received from said optical sensor and to convert the sum into a numerical data signal for output; and a rack fixedly provided at one side of the path in which the object to be measured is reciprocated, and meshed with said input gear, for enabling said input shaft to be rotated upon movement of the object to be measured.

2. The device displacement measuring apparatus of claim 1, wherein said light emitter comprises a light emitting diode controlled to emit light through the peripheral through holes of said optical grid toward said light sensor, and said light sensor comprises a photosensitive transistor adapted to detect light from said light emitting diode.

3. The device displacement measuring apparatus of claim 1 further comprising an amplification gear train pivoted to the inside of said housing and coupled between said input shaft and said optical grid for enabling said optical grid to be rotated at a higher speed than said input shaft upon displacement of the object to be measured.

4. The device displacement measuring apparatus 1, wherein said counting and display circuit comprises a liquid crystal display adapted to display said numerical data signal.
